(19) United States
(12) Patent Application Publication
(10) Pub. No.: US 2025/0076585 A1
(43) Pub. Date: Mar. 6, 2025

(54) DEVICES, SYSTEMS, AND METHODS FOR OPTICAL TRANSMITTANCE AND REFLECTION

(71) Applicant: CORNING RESEARCH & DEVELOPMENT CORPORATION, CORNING, NY (US)

(72) Inventors: Lingling Hu, Fort Worth, TX (US); Yan Hua, Keller, TX (US); Manuel Jesus Ortiz Salazar, Merida (MX); Abel Perez Fajardo, Reynosa (MX); Peter Gerard Wigley, Corning, NY (US)

(21) Appl. No.: 18/817,946

(22) Filed: Aug. 28, 2024

Related U.S. Application Data
(60) Provisional application No. 63/535,398, filed on Aug. 30, 2023.

(51) Int. Cl. G02B 6/32; G02B 6/42

(52) U.S. Cl. CPC G02B 6/32; G02B 6/4206; G02B 6/4215

(57) ABSTRACT

Devices, systems, and methods for optical transmittance and reflection are disclosed. Some such devices include a first lens configured to receive optical communication signals from a first fiber, a second lens configured to pass filtered optical communication signals to a second fiber, and a filter disposed between the first lens and the second lens. The first lens is configured to expand the optical communication signals coming from the first fiber to cause the optical communication signals to travel in a uniform pattern through the filter. The filter is configured to allocate the optical communication signals to form return optical communication signals and the filtered optical communication signals. The return optical communication signals are reflected back for evaluation, and the second lens is configured to redirect the filtered optical communication signals into the second fiber.

### RELATED APPLICATIONS

This application claims the benefit of priority of U.S. Provisional Application Ser. No. 63/535,398 filed on Aug. 30, 2023, the content of which is relied upon and incorporated herein by reference in its entirety.

### FIELD

Example embodiments of the present disclosure generally relate to optical networks and, more particularly to, devices, systems, and methods for optical transmittance and reflection within optical networks.

### BACKGROUND

Optical fiber is the signal guide and transmit media for broadband signals. When the integrity of an optical fiber is affected (for example, accidentally damaged due to construction and/or during installation), the network service of end users is impacted or even lost. Current methods of checking the health of an optical fiber network requires a device to be temporarily plugged into the optical fiber network and requires the optical network to be inactive while the device is being used. Thus, end users lose their internet service temporarily anytime such devices are used to determine the integrity of an optical fiber network.

Improvements in the foregoing are desired.

### BRIEF SUMMARY

Some example embodiments of the present disclosure include devices, systems, and methods for optical transmittance and reflection within an optical network while the optical network is active. Moreover, such devices, systems, and methods are configured to be performable during normal usage scenarios such that end users experience minimal to no interruption in services.

Advantages of the devices, systems, and methods disclosed herein include free space features that reduce cleaning requirements and increase reliability. Further, some such devices are pluggable between connectors in a very simple way. In some embodiments, such devices may be permanently installed within an optical network and may be usable without interruption of network (e.g., internet) service to end users. Additionally or alternatively, such devices can be taken out whenever desired without complication and without altering the optical network.

Some embodiments of the present disclosure include a device with a first lens and a second lens within a housing of the device. A filter may be disposed between the first lens and the second lens. Further, the device may be connected to a first fiber and a second fiber. The first lens may be configured to expand optical communication signals coming from the first fiber to cause the optical communication signals to travel in a uniform pattern through the filter, and the filter may be configured to allocate the optical communication signals to form filtered optical communication signals and return optical communication signals. The second lens may be configured to redirect the filtered optical communication signals to the second fiber, and the return optical communication signals may be reflected back for evaluation.

In an example embodiment, a device for optical transmittance and reflection is provided. The device includes a housing defining an interior volume, a first lens disposed within the interior volume and configured to receive optical communication signals from a first fiber, and a second lens disposed within the interior volume. The second lens is configured to pass filtered optical communication signals to a second fiber. The device also includes a filter disposed within the interior volume between the first lens and the second lens. The first lens is configured to expand the optical communication signals coming from the first fiber to cause the optical communication signals to travel in a uniform pattern through the filter. The filter is configured to allocate the optical communication signals to form return optical communication signals and the filtered optical communication signals. The return optical communication signals are reflected back for evaluation, and the second lens is configured to redirect the filtered optical communication signals into the second fiber.

In some embodiments, the interior volume may further include free space between the first lens and the second lens.

In some embodiments, the device may be installed within a system, and a status of the system may be determined using the device while the system is active.

In some embodiments, the device may be permanently installed within the system.

In some embodiments, the filtered optical communication signals may define a first wavelength range.

In some embodiments, customer network services resulting from the second fiber may utilize signals with wavelengths in the first wavelength range.

In some embodiments, the filtered optical communication signals may be at least 90 percent of the optical communication signals, and the return optical communication signals may be less than 10 percent of the optical communication signals.

In some embodiments, the filter may be connected to the first lens.

In some embodiments, a glass substrate may be disposed between the first lens and the filter.

In some embodiments, the first lens may include a first flat surface, and the second lens may include a second flat surface.

In some embodiments, the first lens may include a first angled surface, and the second lens may include a second angled surface.

In some embodiments, the first angled surface may be angled 8 degrees with respect to a vertical axis, and the second angled surface may be angled 8 degrees with respect to the vertical axis.

In some embodiments, the first fiber may be removably attached to a first connector, and the second fiber may be removably attached to a second connector.

In some embodiments, the first lens and the second lens may be fixed within the interior volume of the device via a fixer tube, and the fixer tube may align the first lens and the second lens in a preset position within the device.

In some embodiments, a first fixture may be used to place the first lens within the fixer tube, and a second fixture may be used to place the second lens within the fixer tube.

In some embodiments, the first fixture may be removed from the fixer tube, and a first ferule may be disposed within the fixer tube. The second fixture may be removed from the fixer tube, and a second ferule may be disposed within the fixer tube.

In some embodiments, the first lens may be configured to receive the optical communication signals from a first plurality of fibers, and the second lens may be configured to pass the filtered optical communication signals to a second plurality of fibers.

In some embodiments, the first plurality of fibers may be removably attached to one or more first connectors, and the second plurality of fibers may be removably attached to one or more second connectors.

In some embodiments, the first lens may be a gradient index lens.

In some embodiments, the second lens may be a gradient index lens.

In another example embodiment, a system for optical transmittance and reflection is provided. The system includes a first fiber, a second fiber, and a device. The device includes a housing defining an interior volume, a first lens disposed within the interior volume and configured to receive optical communication signals from the first fiber, and a second lens disposed within the interior volume. The second lens is configured to pass filtered optical communication signals to the second fiber. The device also includes a filter disposed within the interior volume between the first lens and the second lens. The first lens is configured to expand the optical communication signals coming from the first fiber to cause the optical communication signals to travel in a uniform pattern through the filter. The filter is configured to allocate the optical communication signals to form return optical communication signals and the filtered optical communication signals. The return optical communication signals are reflected back for evaluation, and the second lens is configured to redirect the filtered optical communication signals into the second fiber.

In some embodiments, the system may further include a tester system configured to receive the return optical communication signals and determine whether a repair is needed.

In another example embodiment, a method of forming a device for optical transmittance and reflection is provided. The method includes providing a housing defining an interior volume, positioning a filter within the interior volume, disposing a first lens within the interior volume such that the first lens is configured to receive optical communication signals from a first fiber, and disposing a second lens within the interior volume such that the second lens is configured to pass filtered optical communication signals to a second fiber. The first lens is configured to expand the optical communication signals coming from the first fiber to cause the optical communication signals to travel in a uniform pattern through the filter. The filter is configured to allocate the optical communication signals to form return optical communication signals and the filtered optical communication signals. The return optical communication signals are reflected back for evaluation, and the second lens is configured to redirect the filtered optical communication signals into the second fiber.

In some embodiments, positioning the filter within the interior volume and disposing the first lens within the interior volume may include positioning the filter on a glass substrate and positioning the glass substrate onto the first lens.

In some embodiments, disposing the first lens within the interior volume may further include sliding a first fixture through a first end of a fixer tube to dispose the first lens within the fixer tube, removing the first fixture from the fixer tube, and positioning a first ferule within the first end of the fixer tube. Disposing the second lens within the interior volume may further include sliding a second fixture through a second end of the fixer tube to dispose the second lens within the fixer tube, the second end of the fixer tube being opposite the first end of the fixer tube, removing the second fixture from the fixer tube, and positioning a second ferule within the second end of the fixer tube.

In another example embodiment, a method of testing optical communication signals while still providing transmittance of optical communication signals is provided. The method includes positioning a first lens, a filter, and a second lens between a first fiber and a second fiber, transmitting optical communication signals from the first fiber to the first lens, receiving filtered optical communication signals at a downstream position, receiving return optical communication signals at an upstream position, and determining whether the return optical communication signals satisfy a predetermined threshold quality. The filter is configured to allocate the optical communication signals to form the return optical communication signals and the filtered optical communication signals. The return optical communication signals are reflected back for evaluation, and the second lens is configured to redirect the filtered optical communication signals into the second fiber.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 shows an example passive optical network layout, in accordance with some embodiments disclosed herein;

FIG. 2 shows an example system including a device for optical transmittance and reflection, in accordance with some embodiments disclosed herein;

FIG. 3 illustrates a cross-sectional view of an example system and device such as shown in FIG. 2, showing an example first lens, filter, and second lens disposed within an interior volume of the device, in accordance with some embodiments disclosed herein;

FIG. 4 illustrates a cross-sectional view of another example system and device such as shown in FIG. 2, showing another first lens, the filter, and another second lens disposed within the interior volume of the device, the first lens and the second lens having angled surfaces, in accordance with some embodiments disclosed herein;

FIG. 5 shows a cross-sectional view of an example system and device such as shown in FIG. 2, showing the first lens, another filter, and the second lens disposed within the interior volume of the device, the filter being disposed directly onto the first lens, in accordance with some embodiments disclosed herein;

FIG. 6 shows a cross-sectional view of an example system and device such as shown in FIG. 2, showing the first lens, another filter, and the second lens disposed within the interior volume of the device, the filter being disposed directly onto the first lens, in accordance with some embodiments disclosed herein;

FIG. 7 shows a first lens in connection with a first fiber and a second fiber, a second lens in connection with a third fiber and a fourth fiber, and a filter disposed on the first lens, in accordance with some embodiments disclosed herein;

FIG. 8 shows the system and device of FIG. 2 with a fixer tube disposed therewithin, in accordance with some embodiments disclosed herein;

FIG. 9 shows a front view of an adapter and the fixer tube of the device of FIG. 8, in accordance with some embodiments disclosed herein;

FIG. 10 shows the fixer tube of FIGS. 8-9 with the first lens and the second lens of FIG. 5 being pushed therein with a first fixture and a second fixture, in accordance with some embodiments disclosed herein;

FIG. 11 shows the fixer tube of FIG. 10 with the first fixture having been replaced by a first ferule and the second fixture having been replaced by a second ferule, in accordance with some embodiments disclosed herein;

FIG. 12 shows a first lens and a filter positioned within a first region of a chart and a second lens positioned within a second region of the chart, in accordance with some embodiments discussed herein;

FIG. 13A shows a flow of the optical communication signals of FIG. 12 from the first fiber to the first lens, in accordance with some embodiments disclosed herein;

FIG. 13B is a chart showing gaussian beam profiles of the flow of the optical communication signals of FIG. 13A, in accordance with some embodiments disclosed herein;

FIG. 14A shows a flow of the optical communication signals of FIG. 12 from the first lens to the second lens within the first region, in accordance with some embodiments disclosed herein;

FIG. 14B is a chart showing gaussian beam profiles of the flow of the optical communication signals of FIG. 14A, in accordance with some embodiments disclosed herein;

FIG. 15A shows a flow of the optical communication signals of FIG. 12 from the first lens to the second lens within the second region, in accordance with some embodiments disclosed herein;

FIG. 15B is a chart showing gaussian beam profiles of the flow of the optical communication signals of FIG. 15A, in accordance with some embodiments disclosed herein;

FIG. 16A shows a flow of the optical communication signals of FIG. 12 from the second lens to the second fiber, in accordance with some embodiments disclosed herein;

FIG. 16B is a chart showing gaussian beam profiles of the flow of the optical communication signals of FIG. 16A, in accordance with some embodiments disclosed herein;

FIG. 17 is a flowchart showing a method for forming a device for optical transmittance and reflection, in accordance with some embodiments disclosed herein; and

FIG. 18 is a flowchart showing a method for testing optical communication signals while still providing transmittance of optical communication signals, in accordance with some embodiments disclosed herein.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout.

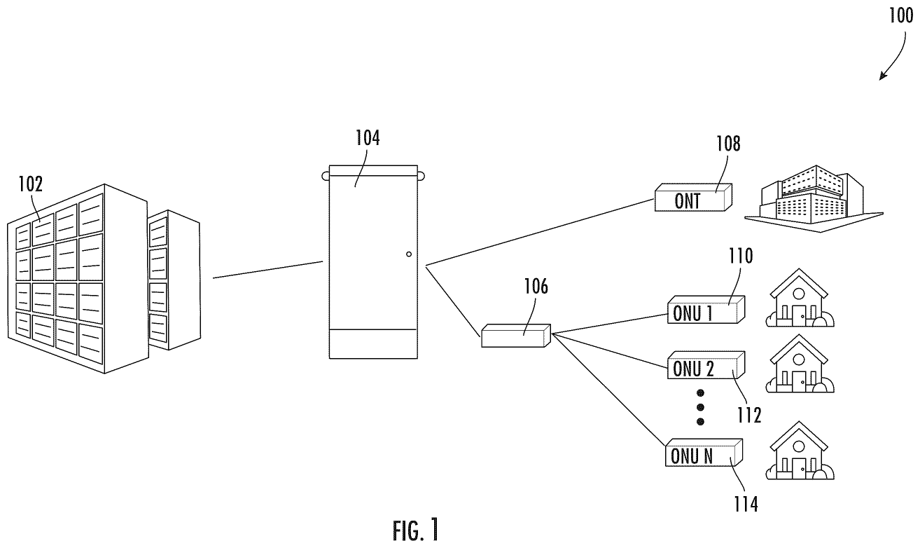

Passive optical networks (PONs), such as fiber to the promise (FTTP), fiber to the business (FTTB) and fiber to the home (FTTH) are used to deliver broadband network access to end users for practical applications such as video conferencing, telephone calls, and online streaming. FIG. 1 shows an example PON 100. Optical signals generated by the optical line terminals (OLTs) 102, which are located in the data center/headend, are transmitted in the network. The optical signals go through passive optical devices such as a fiber distribution hub (FDH) 104 to distribute the signals into different directions. Further, an optical splitter 106 may be used to divide the signals. The signals may ultimately feed into optical network terminals (ONTs) and/or optical network units (ONUs) such as ONT 108 and ONUs 110, 112, and 114.

Currently, optical time domain reflectometry (OTDR) is used to monitor a health status of a PON (e.g., PON 100) by sending single or continuous light pulses into an optical fiber and measure the returning signal strength. OTDR devices are sometimes positioned together with optical line terminals inside data centers and can be used to measure a fiber status of a whole network link. For example, an optical reflector can function as a mirror to reflect a signal from the OTDR device. A typical practical application for the optical reflector is to put it in ONTs and/or ONUs, such as the ONT 108 and the ONUs 110, 112, and 114, as shown in FIG. 1, and check the optical path from the side of the OLTs 102 to the end with the ONT 108 and the ONUs 110, 112, and 114. A normal returned signal strength means the network is functioning normally, a low returned signal means there is fiber damage in the network (e.g., there is likely negatively affected downstream network service), and no signal return means the fiber is totally broken (e.g., there is likely lost network service for at least some end users).

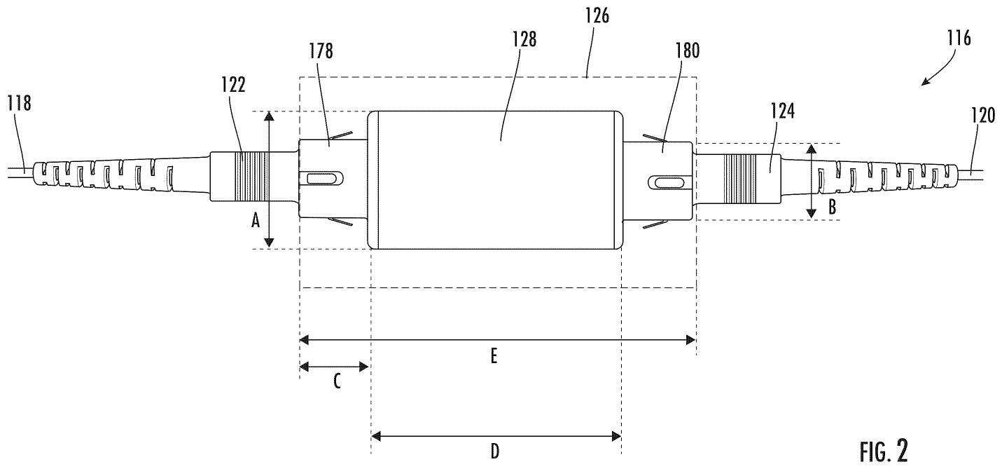

FIG. 2 shows a system 116 that includes a device 126 having a housing 128, a first adapter 178, and a second adapter 180. The device 126 is connected, through a first connector 122 being plugged into the first adapter 178, to a first fiber 118. Similarly, the device 126 is connected, through a second connector 124 being plugged into the second adapter 180, to a second fiber 120. In some embodiments, the first fiber 118 may be removably attachable to the first connector 122 by way of, e.g., the first adapter 178, and the second fiber 120 may be removably attachable to the second connector 124 by way of, e.g., the second adapter 180. Other connection methods are also contemplated within the scope of this disclosure.

The device 126 may be plugged into an optical network, such as anywhere in the PON 100 in FIG. 1, and the device 126 may be used to achieve optical transmittance and reflection simultaneously. For example, instead of having to disrupt an optical network, plug a device into the optical network, obtain reflection values, unplug the device, and then restore the optical network to its normal transmittance operations, the device 126 is capable of being permanently or semi-permanently (e.g., removably installed) installed into an optical network and can conduct optical transmittance and reflection activities at the same time such that the optical network is not affected from an end-user's perspective. In other words, in some embodiments, the device 126 may be installed within a system such as an optical network, and a status of the system can be determined using the device 126 while the system is active. The device 126 may be permanently installed into the system in some embodiments, but, for example, not in all embodiments.

The device 126 may have a length E. For example, the length E may be approximately 42.8 millimeters. Further, the housing 128 of the device 126 may have a width A and a length D. For example, the width A may be approximately 22.0 millimeters, and the length D may be approximately 18.4 millimeters. The first adapter 178 and the second adapter 180 may have widths B and lengths C. For example, the widths B of the first adapter 178 and the second adapter 180 may be approximately 12.8 millimeters, and the lengths C of the first adapter 178 and the second adapter 180 may be approximately 12.2 millimeters. Further, a thickness of the system 116 may be, e.g., between 1.5 millimeters and 9.4 millimeters. However, it should be appreciated that any other length, width, and/or thickness values are contemplated within the scope of this disclosure.

FIG. 3 shows a cross-sectional view of the system 116 of FIG. 2. As shown, the housing 128 defines an interior volume 141, and disposed within the interior volume 141 are a first lens 130, a filter 142, and a second lens 132, along with free space (e.g., between the first lens 130 and the second lens 132). In some embodiments, the first lens 130 may be a gradient index lens such as a GRIN-lens or a G-lens, and in some embodiments, the second lens 132 may be a gradient index lens such as a C-lens, but in other embodiments, the first lens 130 and the second lens 132 may be any other types of lenses. In the embodiment shown in FIG. 3, the first lens 130 includes a first flat surface 144 and the second lens 132 includes a second flat surface 146. Further, the filter 142 is connected to a glass substrate 140, which is connected to the first lens 130. It should be appreciated that, in other embodiments, such as will be described herein, the first lens 130 and the second lens 132 may have non-flat surfaces and/or may have a filter that is connected directly to the first lens 130. Further, in some other embodiments, a filter may be disposed within the interior volume 141 between the first lens 130 and the second lens 132 without being connected to the first lens 130. Other configurations are also contemplated within the scope of this disclosure.

Still referring to FIG. 3, the first lens 130 may be configured to receive optical communication signals 134 from the first fiber 118. Further, the first lens 130 may be configured to expand the optical communication signals 134 coming from the first fiber 118 to cause the optical communication signals 134 to travel in a uniform pattern through the filter 142. The filter 142 may then allocate the optical communication signals 134 to form return optical communication signals 138 and filtered optical communication signals 136. The return optical communication signals 138 may be reflected back for evaluation, and the second lens 132 may be configured to redirect the filtered optical communication signals 136 into the second fiber 120. In some embodiments, a tester system may be configured to receive the return optical communication signals and determine whether a repair is needed. Further, in some embodiments, the filtered optical communication signals 136 may define a first wavelength range, and customer network services resulting from the second fiber 120 may utilize signals with wavelengths in the first wavelength range.

In some embodiments, the filtered optical communication signals may be at least 90 percent of the optical communication signals, and the return optical communication signals may be less than 10 percent of the optical communication signals. However, in some other embodiments, the filtered optical communication signals may be more or less than 90 percent of the optical communication signals, and the return optical communication signals may be more or less than 10 percent of the optical communication signals.

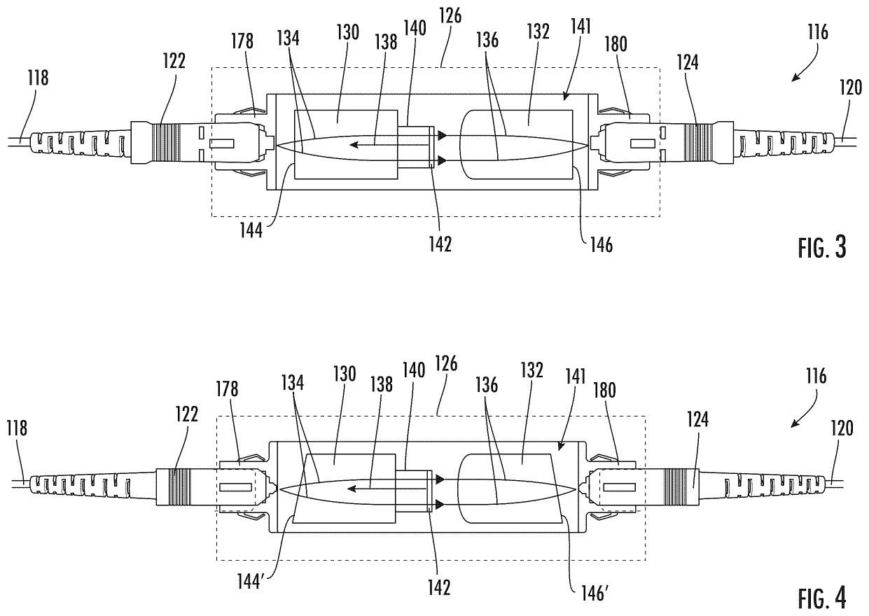

FIG. 4 shows the same system 116 of FIG. 3. However, in the embodiment shown in FIG. 4, the first lens 130 includes a first angled surface 144′ and the second lens 132 includes a second angled surface 146′. For example, the first angled surface 144′ may be angled 8 degrees with respect to a vertical axis (e.g., a vertical axis defined by the first flat surface 144 in FIG. 3), and the second angled surface 146′ may be angled 8 degrees with respect to the vertical axis. Other angle values are also contemplated within the scope of this disclosure. Further, other surface configurations are also contemplated within the scope of this disclosure. For example, the first flat surface 144 of FIG. 3, the first angled surface 144′ of FIG. 4, the second flat surface 146 of FIG. 3, and/or the second angled surface 146′ of FIG. 4 may be irregular surface(s). Notably, such angled surfaces may be appropriate depending on the type of optical signal and/or type of fibers being utilized within the network.

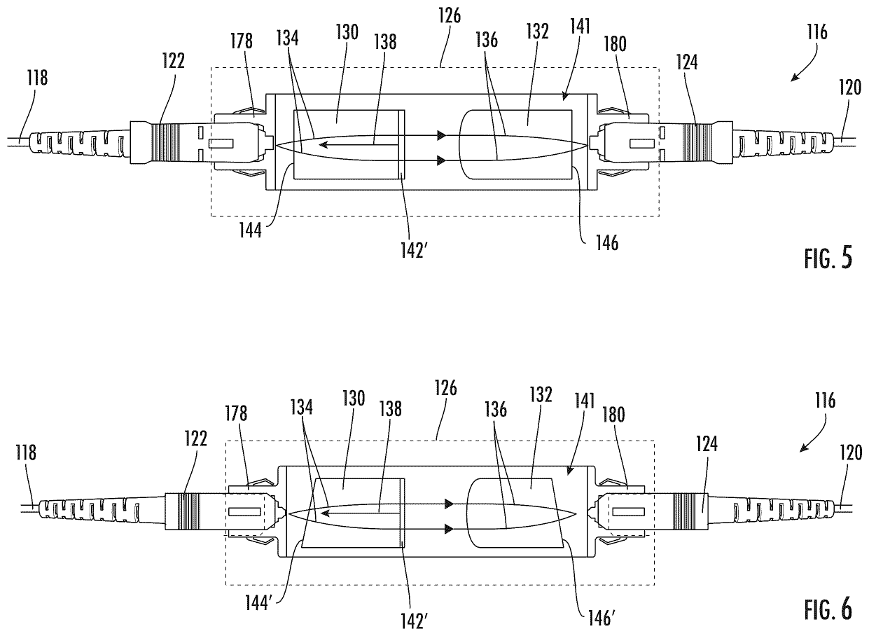

FIG. 5 shows the same system 116 of FIG. 3. However, in the embodiment shown in FIG. 5, a filter 142′ is disposed directly onto the first lens 130 with no glass substrate therebetween. FIG. 6 shows the same system 116 of FIG. 5 with the filter 142′ disposed directly onto the first lens 130. However, in the embodiment shown in FIG. 6, the first lens 130 includes the first angled surface 144′ and the second lens 132 includes the second angled surface 146′ of FIG. 4. It should be appreciated that, although the filter 142′ is disposed directly onto the first lens 130 in FIGS. 5-6, in other embodiments, a filter may be disposed between the first lens 130 and the second lens 132 without being attached to the first lens 130 at all. Other configurations are also contemplated within the scope of this disclosure.

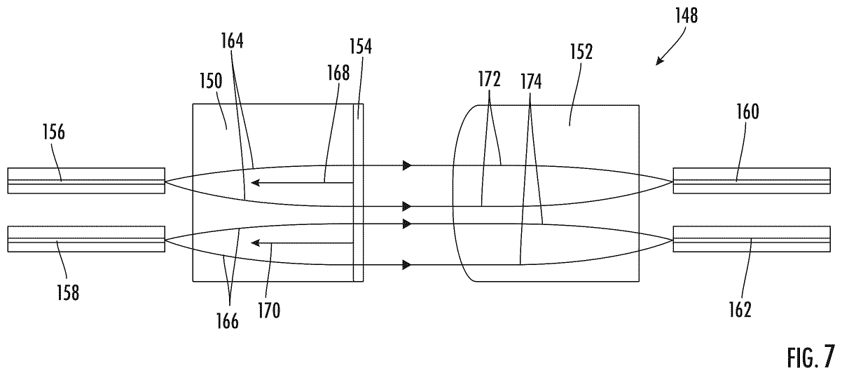

FIG. 7 shows a first lens 150 that is configured to receive optical communication signals from a first plurality of fibers. For example, first optical communication signals 164 are directed from a first fiber 156 into the first lens 150, and second optical communication signals 166 are directed from a second fiber 158 into the first lens 150. Further, a second lens 152 is configured to pass filtered optical communication signals to a second plurality of fibers. For example, first filtered optical communication signals 174 are directed from the second lens 152 to a third fiber 162, and second filtered optical communication signals 172 are directed from the second lens 152 to a fourth fiber 160. The first fiber 156 and the second fiber 158 are removably attached to one or more first connectors (such as the first connector 122 in FIGS. 3-6), and the third fiber 162 and the fourth fiber 160 are removably attached to one or more second connectors (such as the second connector 124 in FIGS. 3-6). It should be appreciated that, in other embodiments, more than two fibers may be connected to the first lens 150, and more than two fibers may be connected to the second lens 152. Further, the amount of fibers connected to the first lens 150 may be unequal to the amount of fibers connected to the second lens 152, in some embodiments. Additionally or alternatively, the first lens 150 and the second lens 152 may be configured to be larger in some embodiments. Other configurations are also contemplated within the scope of this disclosure.

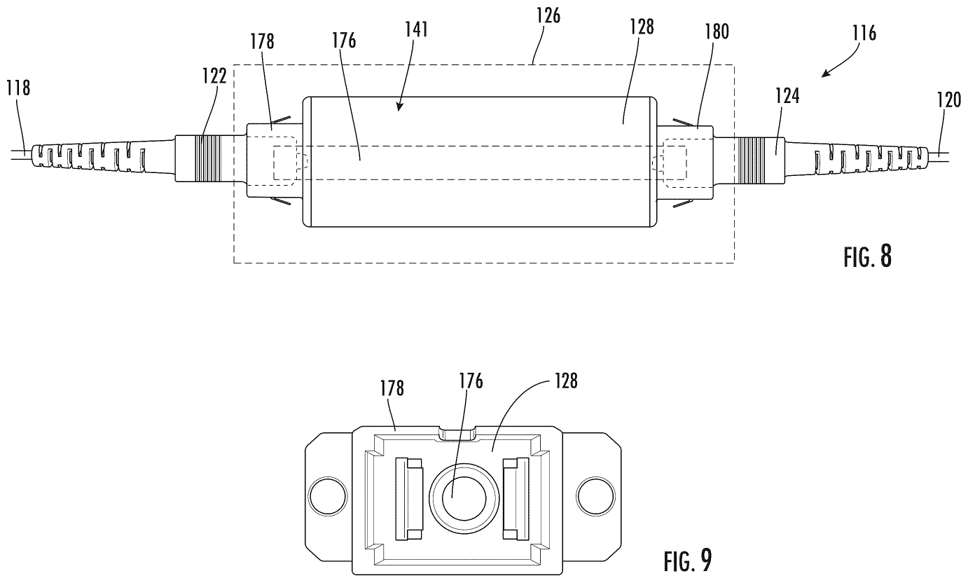

FIG. 8 shows the system 116 with a fixer tube 176 disposed within the housing 128 of the device 126. As will be described herein, the fixer tube 176 may be used for alignment of internal components such as the first lens 130, filter 142′, and/or second lens 132. FIG. 9 shows a side view of the first adapter 178 with the fixer tube 176 disposed within the housing 128 of the device 126.

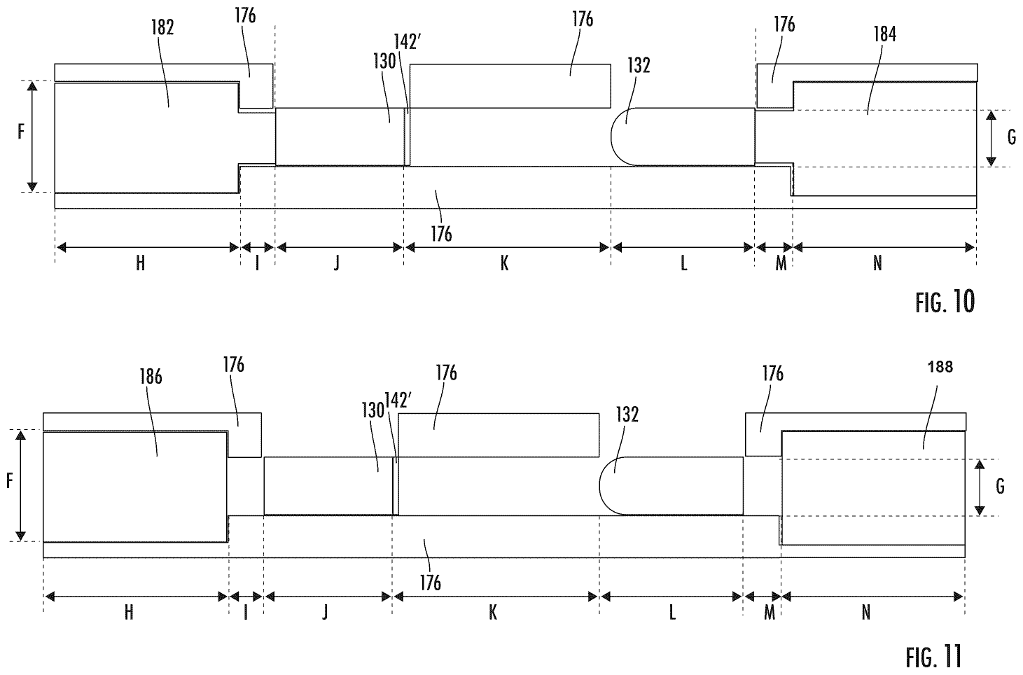

Referring now to FIGS. 10-11, the first lens 130 and the second lens 132 may be fixed within the interior volume of the device 126 via the fixer tube 176. The fixer tube 176 may align the first lens 130 and the second lens 132 in a preset position within the device 126. In some embodiments, as shown in FIG. 10, a first fixture 182 may be used to place the first lens 130 within the fixer tube 176, and a second fixture 184 may be used to place the second lens 132 within the fixer tube 176. The filter 142′ may be pre-positioned within the fixer tube 176 and/or the device 126, or it may be placed into the fixer tube 176 along with the first lens 130 using the first fixture 182. As shown in FIG. 11, the first fixture 182 may be removed from the fixer tube 176, and a first ferule 186 may be disposed within the fixer tube 176. Similarly, the second fixture 184 may be removed from the fixer tube 176, and a second ferule 188 may be disposed within the fixer tube 176.

The fixer tube 176 may have a first inner width F and a second inner width G. For example, the first inner width F may be approximately 2.5 millimeters, and the second inner width G of the fixer tube 176 may be approximately 1.0 millimeter. The first fixture 182 may have a first length H and a second length I. Similarly, the second fixture 184 may have a first length N and a second length M. For example, the first length H and the first length N may each be approximately 6.1 millimeters. The second length I may be approximately 0.2 millimeters, and the second length M may be approximately 0.6 millimeters. Further, each of the first fixture 182 and the second fixture 184 may have widths that are approximately equal to the first inner width F and the second inner width G of the fixer tube 176. The first ferule 186 in FIG. 11, which may replace the first fixture 182 shown in FIG. 10, may have a length equal to the first length H of the first fixture 182 (e.g., approximately 6.1 millimeters). Similarly, the second ferule 188, which may replace the second fixture 184 shown in FIG. 10, may have a length equal to the first length N of the second fixture 184 (e.g., approximately 6.1 millimeters). The first lens 130 may have a length J, which may be approximately 4.4 millimeters. Further, the first lens 130 may have a width that is approximately equal to the second inner width G of the fixer tube 176. The second lens 132 may have a length L, which may be approximately 2.2 millimeters. Further, the second lens 132 may have a width that is approximately equal to the second inner width G of the fixer tube 176. The fixer tube 176 may also include a portion with a length K that has no components disposed therewithin. The length K may be, e.g., 11.0 millimeters. It should be appreciated that any other length and/or width values for the widths and lengths shown in FIG. 10-11 are contemplated within the scope of this disclosure.

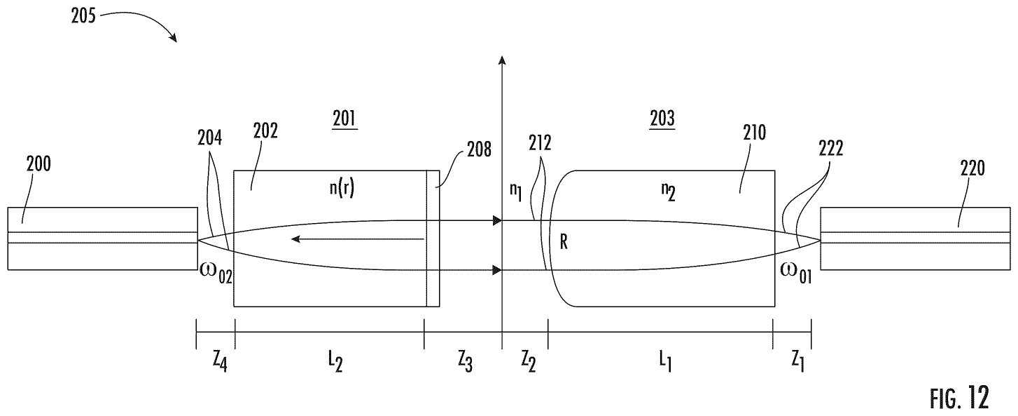

To show a behavior of light along an optical path through a device (such as the device 126), in FIG. 12, the geometry of the device is divided into two regions. Further, FIG. 12 shows a first lens 202 and a filter 208 positioned within a first region 201 of a chart 205 and a second lens 210 positioned within a second region 203 of the chart 205. The first lens 202 is optically connected to a first fiber 200 to receive optical communication signals 204, and the second lens 210 is optically connected to a second fiber 220 configured to receive filtered optical communication signals 222. Filtered optical communication signals 212 pass from the first region 201 to the second region 203 when they travel from the filter 208 to the second lens 210.

In FIG. 12, ω₀₂ is a beam radius from the first fiber 200, and ω₀₁ is a beam radius to the second fiber 220. Further, n(r) is a refractive index GRIN-lens, n₁ is a refractive index air, and n₂ is a refractive index C-lens. R represents a radius of curvature of the C-lens, and L₁, L₂, z₁, z₂, z₃, and z₄ represent lengths (e.g., the lengths and L₁, L₂, z₁, z₂, z₃, and z₄ could be the same or similar to the lengths shown and described with respect to FIGS. 10-11).

In some embodiments, the first lens 202 may be a GRIN-lens, and the second lens 210 may be a C-lens. Further, the first region 201 and the second region 203 may be analyzed for beam diversions using a standard ABCD matrix approach that is typically used to analyze C-lens and GRIN-lens collimators. For example, calculations may be performed for a single mode fiber. The deflection of the optical path of some of the optical communication signals 204 caused by the filter 208 may be negligible because even when the filter 208 thickness (e.g., 18 micrometers) is not categorized as optically opaque, the technology of the filter 208 may be configured so as to prevent a big deviation of the light coming out from it. For this reason, an assumption can be made that the filter's 208 contribution to the light behavior of the optical path of the optical communication signals 204 (which turn into optical communication signals 212) is negligible. Further, for simplicity, it can be determined that the behavior of the light, in the free space region between the GRIN-lens and the C-lens (e.g., in the free space region having length z₃ and z₂), must be collimated.

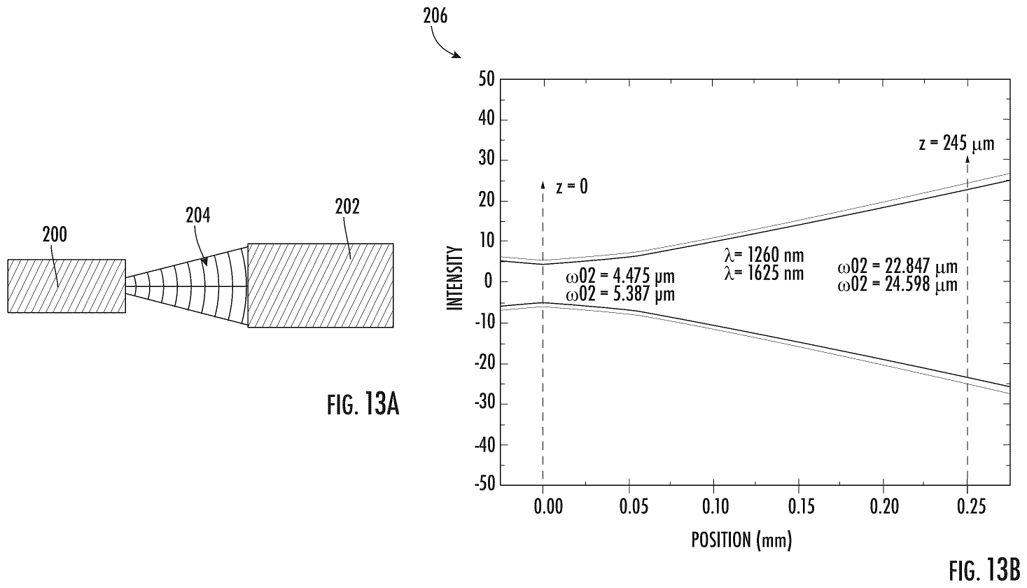

FIG. 13A shows the flow of optical communication signals 204 from the first fiber 200 to the first lens 202. Correspondingly, FIG. 13B is a chart 206 of theoretical gaussian beam profiles of the light coming from the first fiber 200 for the wavelengths 1260 nanometers and 1625 nanometers. Further, the chart 206 shows a theoretical gaussian beam profile generated with the specific parameters shown in FIG. 12 for both the first fiber 200 and the first lens 202 (e.g., a GRIN-lens), respectively. For example, the beam diameters ω₀₂ coming into the first lens 202 (e.g., the GRIN-lens) are 22.847 micrometers for the 1260 nanometer wavelengths and 24.598 micrometers for 1625 nanometer wavelengths, respectively. The length z₄ of the distance between the first lens 202 (e.g., the GRIN-lens) and the first fiber 200 is 245 micrometers for both wavelengths.

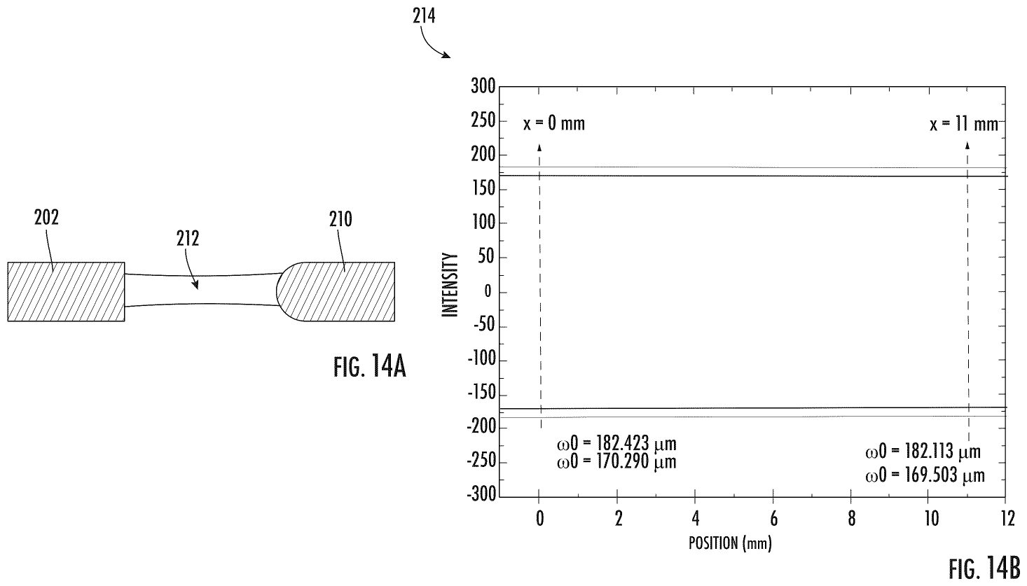

FIG. 14A shows the flow of optical communication signals 212 from the first lens 202 to the second lens 210 within the first region 201. Correspondingly, FIG. 14B is a chart 214 of theoretical gaussian beam profiles of the light coming from the first lens 202 for the wavelengths 1260 nanometers and 1625 nanometers. Further, the chart 214 shows a theoretical gaussian beam profile generated with the specific parameters shown in FIG. 12 for both the first lens 202 (e.g., a GRIN-lens) and the second lens 210 (e.g., a C-lens), respectively. For example, the beam diameters ω₀ coming out of the first lens 202 (e.g., the GRIN-lens) are 170.290 micrometers for the 1260 nanometer wavelengths, and the beam diameters ω₀ coming out of the first lens 202 (e.g., the GRIN-lens) are 182.423 micrometers for the 1625 nanometer wavelengths. The beam diameters ω₀ coming into the second lens 210 (e.g., the C-lens) are 169.503 micrometers for the 1260 nanometer wavelengths, and the beam diameters ω₀ coming into the second lens 210 (e.g., the C-lens) are 182.113 micrometers for the 1625 nanometer wavelengths.

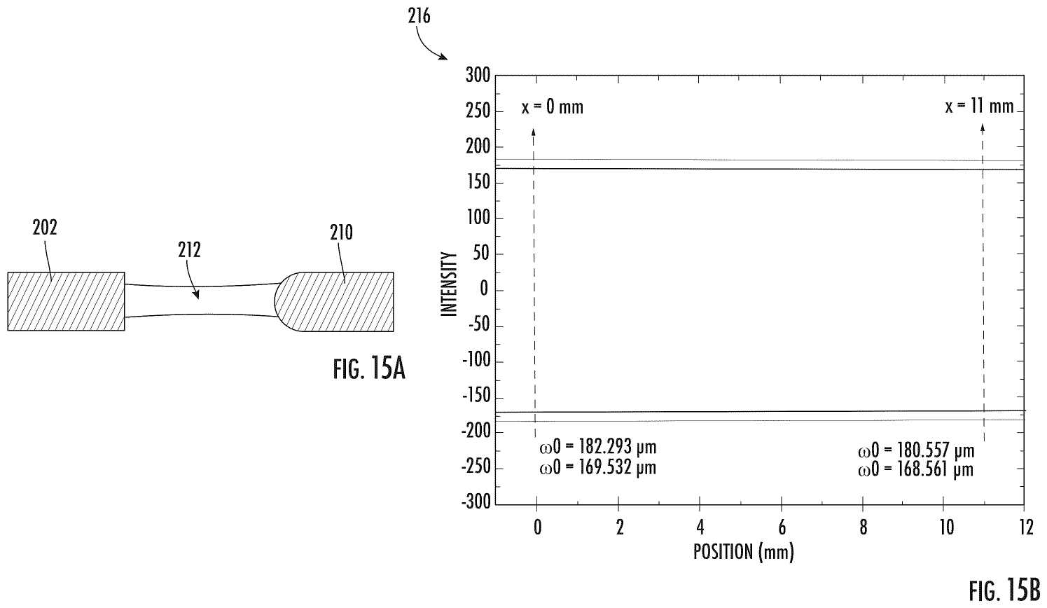

Turning now to the second region 203 (e.g., as shown in FIG. 12), FIG. 15A shows the flow of optical communication signals 212 from the first lens 202 to the second lens 210 within the second region 203. Correspondingly, FIG. 15B is a chart 216 of theoretical gaussian beam profiles of the light coming from the first lens 202 for the wavelengths 1260 nanometers and 1625 nanometers. Further, the chart 216 shows a theoretical gaussian beam profile generated with the specific parameters shown in FIG. 12 for both the first lens 202 (e.g., a GRIN-lens) and the second lens 210 (e.g., a C-lens), respectively. For example, the beam diameters ω₀ coming out of the first lens 202 (e.g., the GRIN-lens) are 169.532 micrometers for the 1260 nanometer wavelengths, and the beam diameters ω₀ coming out of the first lens 202 (e.g., the GRIN-lens) are 182.293 micrometers for the 1625 nanometer wavelengths. The beam diameters ω₀ coming into the second lens 210 (e.g., the C-lens) are 168.561 micrometers for the 1260 nanometer wavelengths, and the beam diameters ω₀ coming into the second lens 210 (e.g., the C-lens) are 180.557 micrometers for the 1625 nanometer wavelengths.

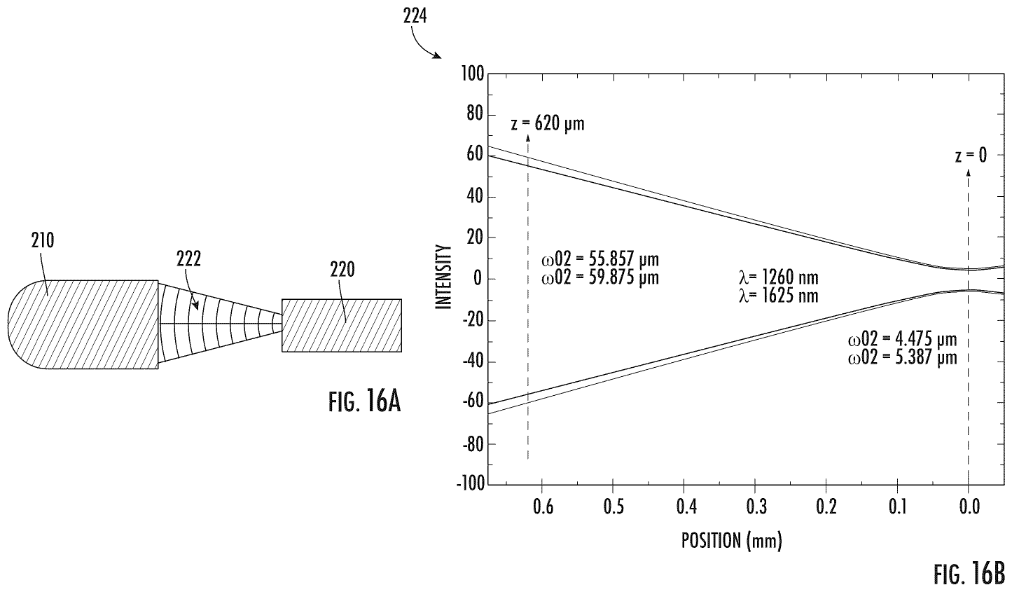

FIG. 16A shows the flow of optical communication signals 222 from the second lens 210 (e.g., the C-lens) to the second fiber 220. Correspondingly, FIG. 16B is a chart 224 of theoretical gaussian beam profiles of the light coming into the second fiber 220 for the wavelengths 1260 nanometers and 1625 nanometers. Further, the chart 224 shows a theoretical gaussian beam profile generated with the specific parameters shown in FIG. 12 for both the second lens 210 (e.g., the C-lens) and the second fiber 220, respectively. For example, the beam diameters ω₀₂ coming out of the second lens 210 (e.g., the C-lens) are 55.857 micrometers for the 1260 nanometer wavelengths and 59.875 micrometers for 1625 nanometer wavelengths, respectively. The beam diameters ω₀₂ coming into the second fiber 220 are 4.475 micrometers for the 1260 nanometer wavelengths and 5.387 micrometers for 1625 nanometer wavelengths, respectively. The length z₁ of the distance between the second lens 210 (e.g., the C-lens) and the second fiber 220 is 620 micrometers for both wavelengths.

### Example Flowchart(s)

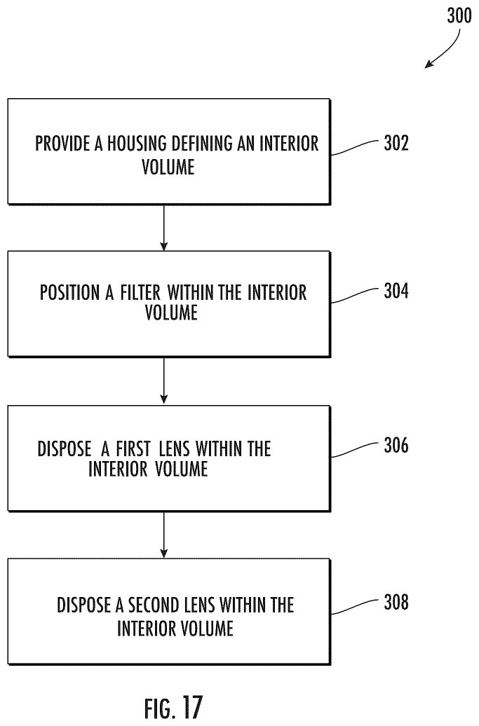

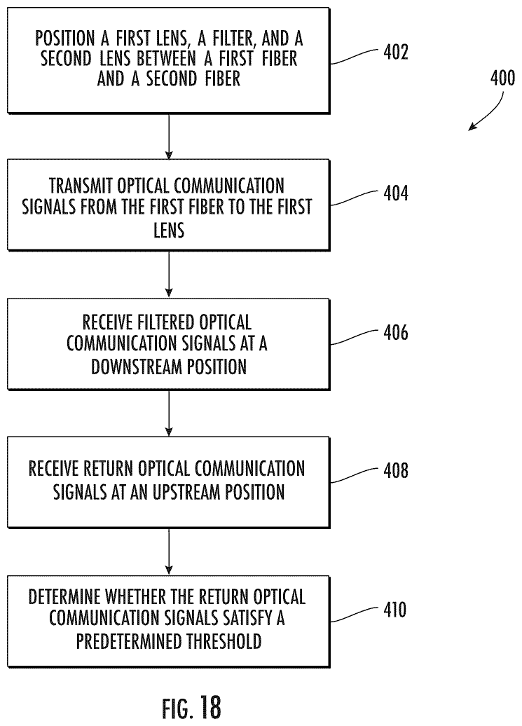

Embodiments of the present disclosure provide various methods for forming a device for optical transmittance and reflection and for testing optical communication signals while still providing transmittance of optical communication signals, such as described herein. Various examples of the operations performed in accordance with some embodiments of the present disclosure will now be provided with reference to FIGS. 17-18.

FIG. 17 illustrates a flowchart according to an example method 300 of forming a device for optical transmittance and reflection according to an example embodiment. The method 300 may include providing a housing defining an interior volume at operation 302. At operation 304, the method may include positioning a filter within the interior volume, as described herein. The filter may be configured to allocate optical communication signals to form return optical communication signals and filtered optical communication signals, and the return optical communication signals may be reflected back for evaluation. In some embodiments, positioning the filter at operation 304 may include positioning the filter on a glass substrate and positioning the glass substrate onto a first lens. In other embodiments, however, operation 304 may include positioning the filter directly onto a first lens. Further, in some other embodiments, operation 304 may include positioning the filter within the interior volume such that it is between a first lens and a second lens but is not attached to the first lens.

At operation 306, the method 300 may include disposing a first lens within the interior volume such that the first lens is configured to receive optical communication signals from a first fiber. The first lens may be configured to expand the optical communication signals coming from the first fiber to cause the optical communication signals to travel in a uniform pattern through the filter. In some embodiments, operation 306 may include sliding a first fixture through a first end of a fixer tube to dispose the first lens within the fixer tube, removing the first fixture from the fixer tube, and positioning a first ferule within the first end of the fixer tube. Other methods of disposing the first lens within the interior volume at operation 306 are also contemplated within the scope of this disclosure, however.

At operation 308, the method 300 may include disposing a second lens within the interior volume such that the second lens is configured to pass filtered optical communication signals to a second fiber. The second lens may be configured to redirect the filtered optical communication signals into the second fiber. In some embodiments, operation 308 may include sliding a second fixture through a second end of a fixer tube to dispose the second lens within the fixer tube, removing the second fixture from the fixer tube, and positioning a second ferule within the second end of the fixer tube. Other methods of disposing the second lens within the interior volume at operation 308 are also contemplated within the scope of this disclosure, however.

Additional manufacturing operations and/or additional usage operations are also contemplated.

FIG. 18 illustrates a flowchart according to an example method 400 of testing optical communication signals while still providing transmittance of optical communication signals, according to an example embodiment. The method 400 may include positioning a first lens, a filter, and a second lens between a first fiber and a second fiber at operation 402. The filter may be configured to allocate optical communication signals to form return optical communication signals and filtered optical communication signals. The filter may be configured to reflect back the return optical communication signals for evaluation, and the second lens may be configured to redirect the filtered optical communication signals into the second fiber.

At operation 404, the method 400 may include transmitting the optical communication signals from the first fiber to the first lens, as described herein. In some embodiments, this may include activating an optical system in which the first lens, the filter, and the second lens are disposed. Activating the optical system may cause optical communication signals to be transmitter through the first fiber to the first lens. The optical communication signals may then, e.g., pass through the filter, and the filter may allocate the optical communication signals into filtered optical communication signals and return optical communication signals, such as described herein.

At operation 406, the method 400 may include receiving filtered optical communication signals at a downstream position. For example, the filtered optical communication signals may pass through the second lens and into the second fiber and be received by an end user.

At operation 408, the method 400 may include receiving return optical communication signals at an upstream position. For example, the return optical communication signals may be reflected backwards within the optical system, such as, in some embodiments, back through the first fiber. In some embodiments, operation 408 may be performed without the optical network being disturbed.

At operation 410, the method 400 may include determining whether the return optical communication signals satisfy a predetermined threshold quality. For example, a normal returned signal strength might indicate that the optical network is functioning normally, a low returned signal might indicate that there is fiber damage in the optical network, and no single return might indicate that a fiber is totally broken (and when a fiber is totally broken, certain end users might lose their internet service).

It should be appreciated that, in some embodiments, operation 404, operation 406, operation 408, and operation 410 may all be performable without an end user's network service being interrupted and/or negatively affected. Further, it should also be appreciated that additional manufacturing operations and/or additional usage operations are also contemplated.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

### CONCLUSION

Many modifications and other embodiments of the disclosures set forth herein may come to mind to one skilled in the art to which these disclosures pertain having the benefit of the teachings presented in the foregoing descriptions and the associated drawings. Therefore, it is to be understood that the embodiments of the disclosure are not to be limited to the specific embodiments disclosed and that modifications and other embodiments are intended to be included within the scope of the disclosure. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

What is claimed is:

1. A device for optical transmittance and reflection, the device comprising:
a housing defining an interior volume;
a first lens disposed within the interior volume and configured to receive optical communication signals from a first fiber;
a second lens disposed within the interior volume, wherein the second lens is configured to pass filtered optical communication signals to a second fiber; and
a filter disposed within the interior volume between the first lens and the second lens,
wherein the first lens is configured to expand the optical communication signals coming from the first fiber to cause the optical communication signals to travel in a uniform pattern through the filter,
wherein the filter is configured to allocate the optical communication signals to form return optical communication signals and the filtered optical communication signals, wherein the return optical communication signals are reflected back for evaluation, and wherein the second lens is configured to redirect the filtered optical communication signals into the second fiber.

2. The device of claim 1, wherein the interior volume further comprises free space between the first lens and the second lens.

3. The device of any of claim 1, wherein the device is installed within a system, and wherein a status of the system can be determined using the device while the system is active.

4. The device of claim 3, wherein the device is permanently installed within the system.

5. The device of any of claim 1, wherein the filtered optical communication signals define a first wavelength range.

6. The device of claim 5, wherein customer network services resulting from the second fiber utilize signals with wavelengths in the first wavelength range.

7. The device of any of claim 1, wherein the filtered optical communication signals are at least 90 percent of the optical communication signals, and wherein the return optical communication signals are less than 10 percent of the optical communication signals.

8. The device of claim 1, wherein the filter is connected to the first lens.

9. The device of claim 8, wherein a glass substrate is disposed between the first lens and the filter.

10. The device of claim 1, wherein the first lens comprises a first flat surface, and wherein the second lens comprises a second flat surface.

11. The device of claim 1, wherein the first lens comprises a first angled surface, and wherein the second lens comprises a second angled surface.

12. The device of claim 11, wherein the first angled surface is angled 8 degrees with respect to a vertical axis, and wherein the second angled surface is angled 8 degrees with respect to the vertical axis.

13. The device of claim 1, wherein the first fiber is removably attached to a first connector, and wherein the second fiber is removably attached to a second connector.

14. The device of claim 1, wherein the first lens and the second lens are fixed within the interior volume of the device via a fixer tube, and wherein the fixer tube aligns the first lens and the second lens in a preset position within the device.

15. The device of claim 14, wherein a first fixture is used to place the first lens within the fixer tube, and wherein a second fixture is used to place the second lens within the fixer tube.

16. The device of claim 15, wherein the first fixture is removed from the fixer tube, wherein a first ferule is disposed within the fixer tube, wherein the second fixture is removed from the fixer tube, and wherein a second ferule is disposed within the fixer tube.

17. The device of claim 1, wherein the first lens is configured to receive the optical communication signals from a first plurality of fibers, and wherein the second lens is configured to pass the filtered optical communication signals to a second plurality of fibers.

18. The device of claim 17, wherein the first plurality of fibers are removably attached to one or more first connectors, and wherein the second plurality of fibers are removably attached to one or more second connectors.

19. The device of claim 1, wherein the first lens is a gradient index lens.

20. The device of claim 1, wherein the second lens is a gradient index lens.
